(19) United States
(12) Patent Application Publication
(10) Pub. No.: US 2014/0029483 A1
(43) Pub. Date: Jan. 30, 2014

(54) METHOD AND APPARATUS FOR TDD VIRTUAL CELL SELECTION

(71) Applicant: QUALCOMM INCORPORATED, San Diego, CA (US)

(72) Inventors: Raghu Narayan CHALLA, San Diego, CA (US); Jun Won CHOI, San Diego, CA (US); Won Joon CHOI, San Diego, CA (US); Fan WANG, Sunnyvale, CA (US); Yongle WU, San Diego, CA (US); Lei KE, San Diego, CA (US)

(73) Assignee: QUALCOMM INCORPORATED, San Diego, CA (US)

(21) Appl. No.: 13/839,925

(22) Filed: Mar. 15, 2013

Related U.S. Application Data
(60) Provisional application No. 61/677,463, filed on Jul. 30, 2012.
(60) Provisional application No. 61/698,468, filed on Sep. 7, 2012.

(51) Int. Cl. H04W 48/16

(52) U.S. Cl. CPC H04W 48/16
USPC 370/280

(57) ABSTRACT

A method, an apparatus, and a computer program product for wireless communication are provided. The apparatus may be a UE. The UE may search for one or more cells during each of a number of search periods, select a first cell that has been detected in at least two of the search periods, and determine an LNA gain based on information associated with the first cell.

### CROSS-REFERENCE TO RELATED APPLICATIONS

This application claims the benefit of U.S. Provisional Application Ser. No. 61/677,463, entitled “Enhanced TDD X2LVirtual Serving Cell Selection Algorithm” and filed on Jul. 30, 2012, and claims the benefit of U.S. Provisional Application Ser. No. 61/698,468, entitled “Method and Apparatus for TDD Virtual Cell Selection” and filed on Sep. 7, 2012, which are expressly incorporated by reference herein in their entireties.

### BACKGROUND

1. Field

The present disclosure relates generally to communication systems, and more particularly, to a method and apparatus for time division duplexing (TDD) virtual cell selection.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be a UE. The UE may search for one or more cells during each of a number of search periods, select a preferred cell from among one or more cells that have been detected in at least two of the search periods when at least one cell has been detected in at least two of the search periods, and determine a low-noise amplifier (LNA) gain based on information associated with the preferred cell.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a communication system.

FIG. 8 is a flow chart of a method of wireless communication.

FIG. 9 is a flow chart of a method of wireless communication.

FIG. 10 is a flow chart of a method of wireless communication.

FIG. 11 is a conceptual data flow diagram illustrating the data flow between different modules/means/components in an exemplary apparatus.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

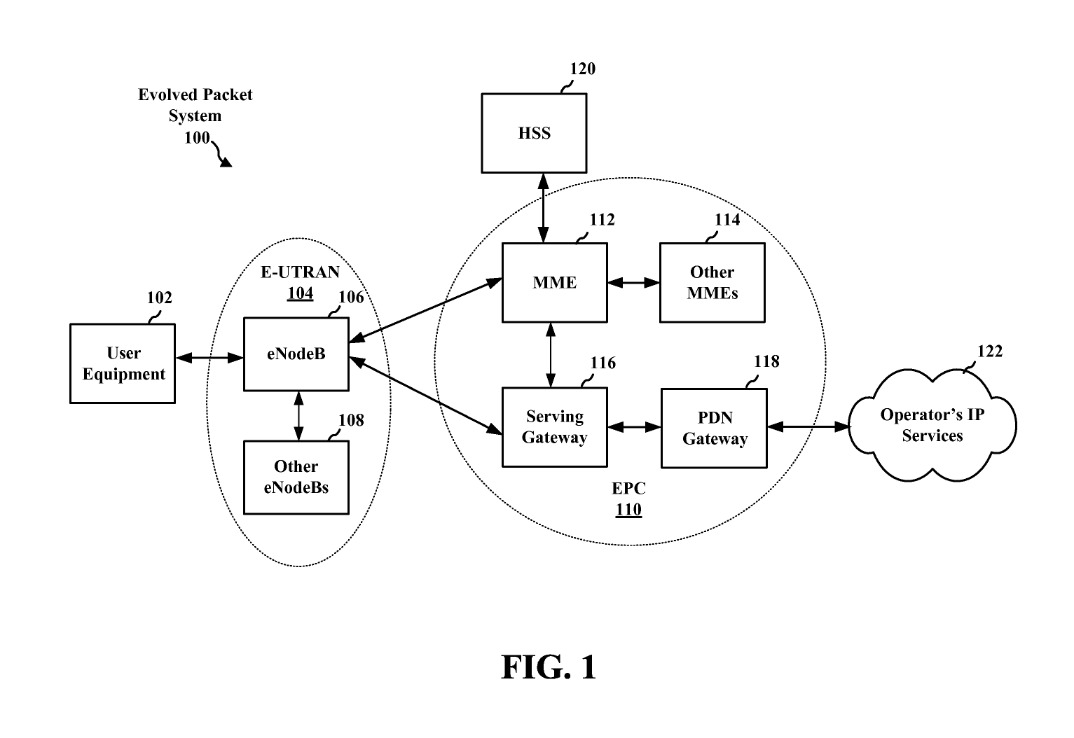

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

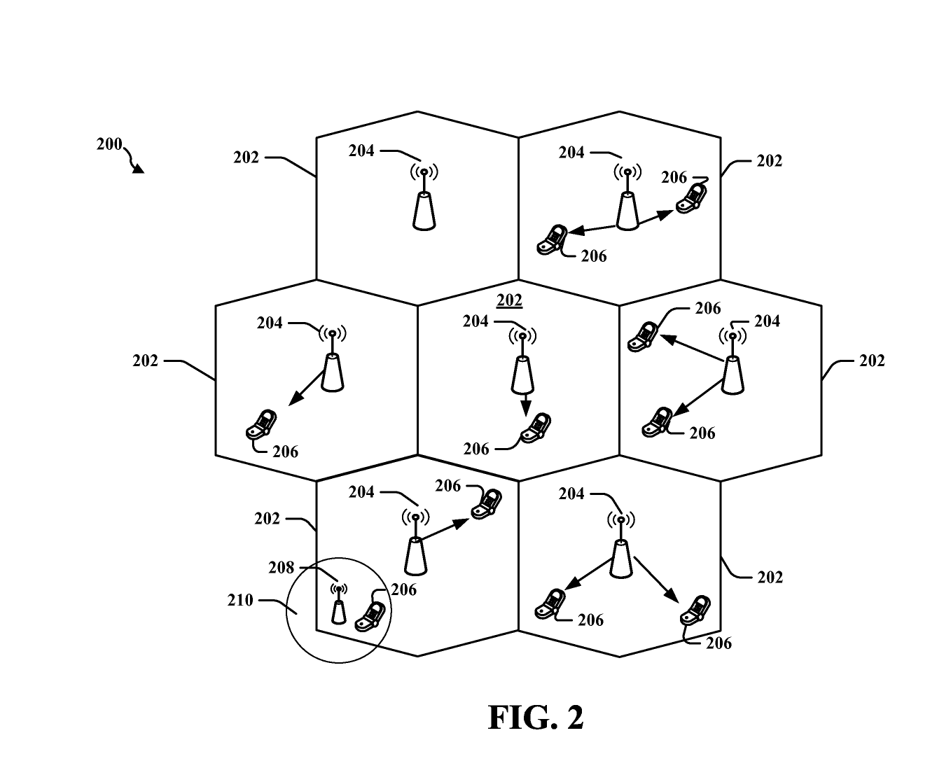

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

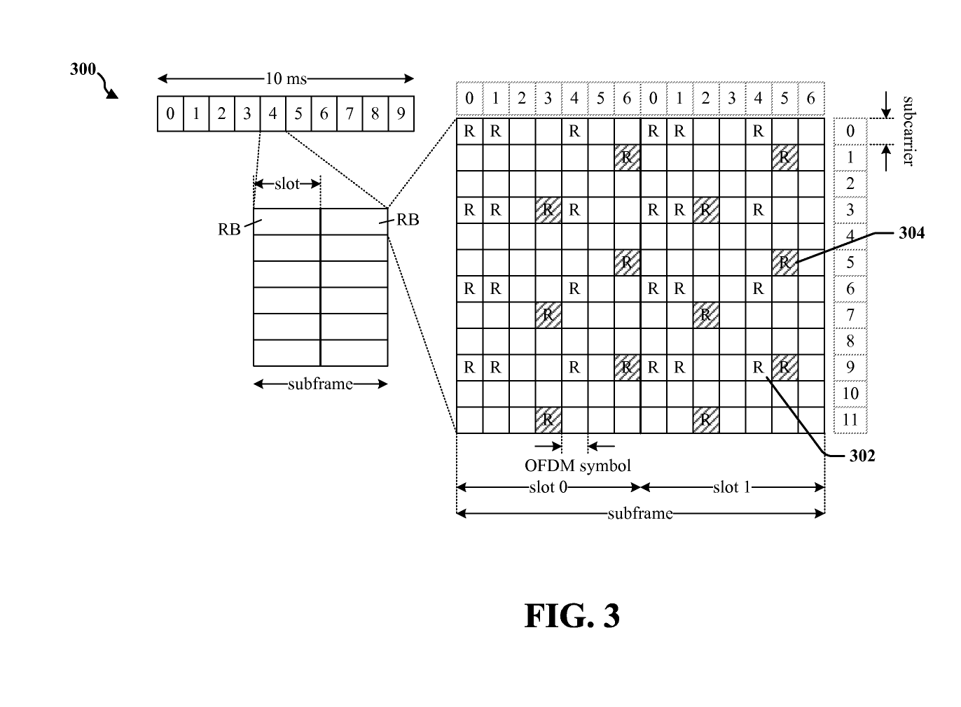

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

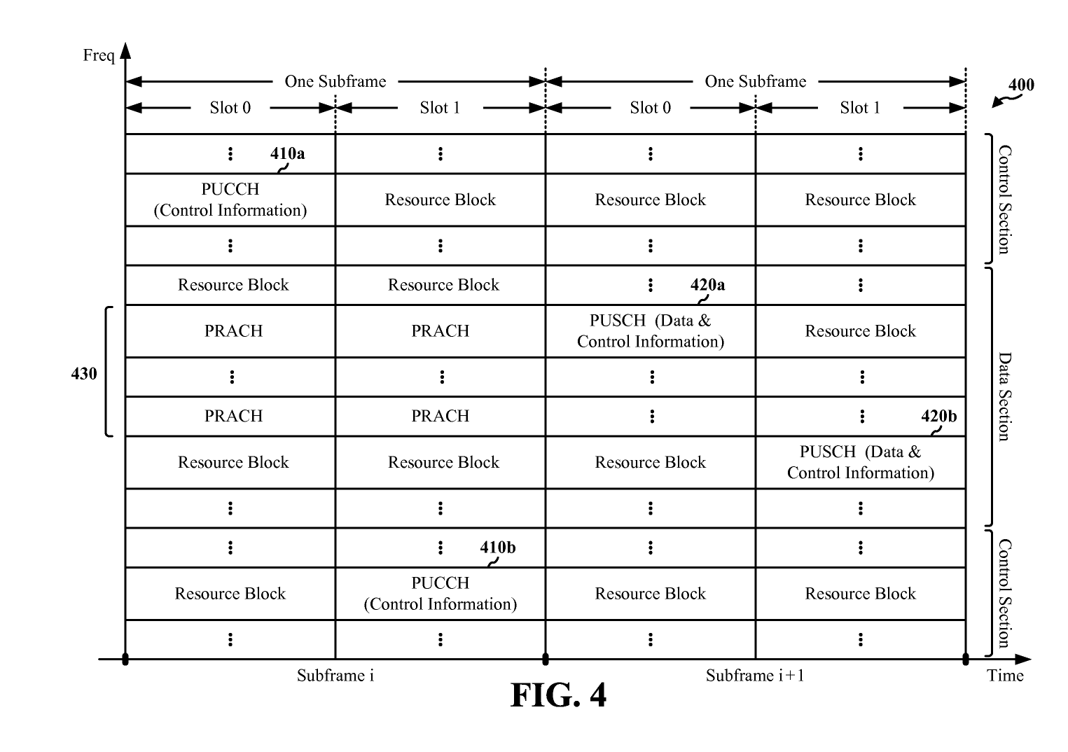

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

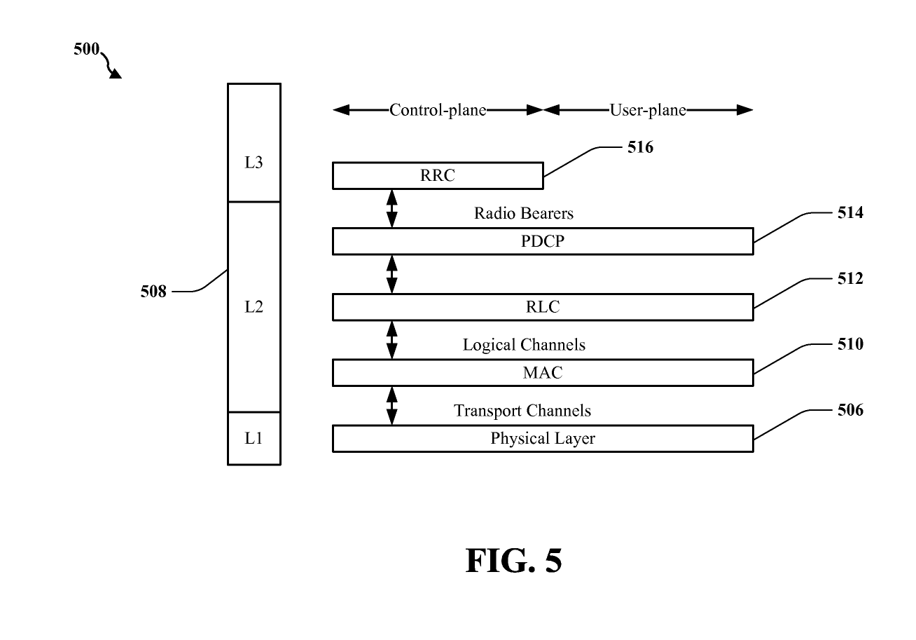

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

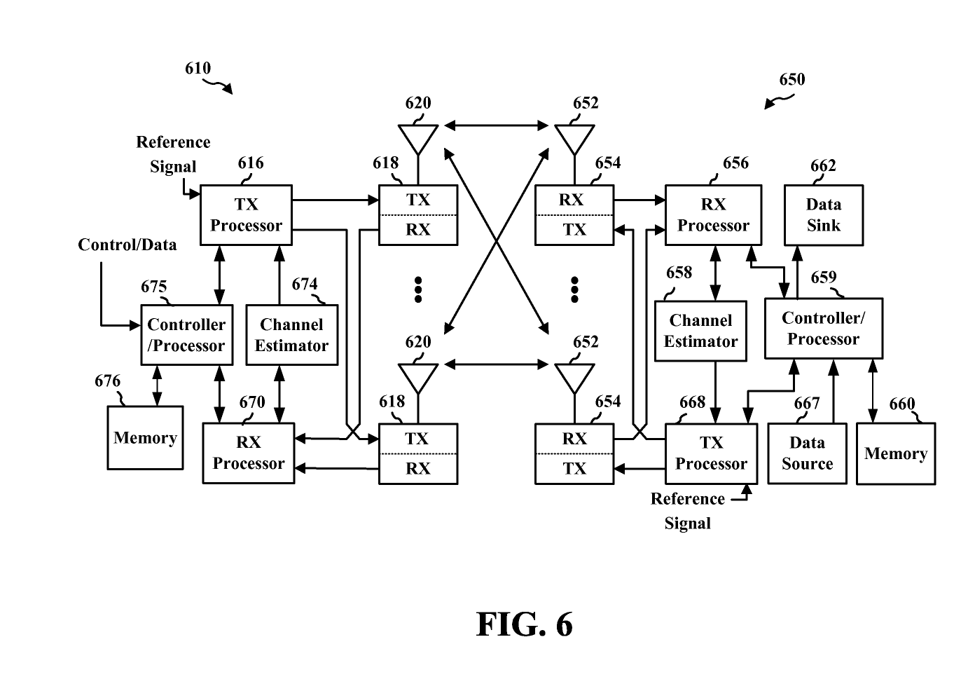

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

In TDD inter radio access technology (IRAT)/inter frequency (IFREQ) neighbor cell measurement, the UE may need to determine the correct downlink low-noise amplifier (LNA) gain for measurement sample collection. Otherwise, the accuracy of the measurements performed by the UE may be affected. Since TDD uses the same frequency for UL and DL transmission, the LNA gain used for measurements of signals (e.g., RSRP signals) from neighboring cells by the UE must be accurately determined. For example, if the LNA gain is too high, saturation may occur and RSRP will not be detectable, whereas if the LNA gain is too small, RSRP will not be accurate due to low signal-to-quantization-noise ratio (SQNR). In one approach, a cell from a neighbor cell list may be picked up and its cell timing information may be used to determine downlink LNA gains. Such a cell may be referred to as a “virtual cell.” In one example, one of the search results per E-UTRA absolute radio frequency channel number (EARFCN) may be declared as a virtual cell. In such example, the timing of the declared virtual cell will be used when the UE performs measurements without a search.

In conventional designs, a virtual cell nominated by a UE is typically a neighbor cell having a secondary synchronization signal (SSS) signal-to-noise ratio (SSS_SNR) that is highest among the neighbor cells in a measurement database (MDB) of the UE and any newly detected cells. In such conventional designs, it is assumed that the probability of the SSS SNR of spurious cells being higher than that of real ncells is close to zero. In practice, although spurious cells are pruned from the MDB every five search gaps (also referred to as “measurement gaps”) based on a “two out of five” pruning rule, the MDB is updated with newly detected cells every search (W2L) or every five gaps (L2L). Therefore, there is no guarantee that spurious cells are not nominated as virtual cells. For example, if a spurious cell has a very large SSS_SNR and it shows up only once, the erroneous timing information of such spurious cell may be used for multiple gaps and, therefore, the LNA gain measured by the UE may not be accurate.

In one conventional design where the MDB is updated with newly detected cells for every search, there will be only four consecutive search gaps opened on one frequency. A first gap may be used for pipeline automatic gain control (AGC) initialization, a second gap may be search dedicated, a third gap may be for sample collection for measurement where the CER_SNR will be reported by the end of the fourth gap, and a fourth gap may be the same as the third gap except that the CER_SNR will be reported by the end of the first gap on another frequency. There may be cell searches scheduled in the last two gaps as well. However, the CER_SNR cannot be used by a UE to select a virtual cell as the report is too late. Therefore, the UE may use the SSS_SNR from the search. In this example, since there is lack of time diversity, there may only be three search results in one frequency. If cells that show up more than twice are maintained, real or actual cells might be pruned out, which may decrease the detection probability. In the previously discussed conventional designs, a UE may be configured to find a cell within a search result that has the largest SSS_SNR as the virtual cell at the beginning of each measurement gap. In one configuration, if no cell is detected, the virtual is not changed. In another configuration, if no cell is detected, the UE may be configured to check the cell in the measurement data base and select the cell with largest SSS_SNR as the virtual cell.

The virtual cell selection method disclosed herein is based on the property that spurious cells are rarely detected twice with the same cell ID. The UE assigns higher priority to the cells that were detected two or more times. In one configuration, such cells that were detected two or more times may be categorized as “preferred cells.” Accordingly, the UE searches for a virtual cell candidate among these preferred cells first. If there are no cells that were detected two or more times, the UE may search for other neighbor candidate cells.

There may be two sources for obtaining neighbor cells. One source may be an MDB that includes cells the UE may measure. The cells in the MDB are usually from pervious detected cells. Another source may be from a searcher. The searcher may report detected cells with the largest SSS_SNR. Ideally, the searcher should report only true neighbor cells. However, the searcher may occasionally report spurious cells. Generally, there are two types of spurious cells, such as ghost cells and uplink spurious cells.

A ghost cell (also referred to as a “systematic spurious cell”) is one that usually gets detected along with true neighbor cells because of the non-zero correlation between different SSS sequences. A ghost cell is likely to be maintained in the MDB for a relatively long time, since it may be detected multiple times. The SSS_SNR of a ghost cell is typically several dB lower than that of its corresponding true neighbor cell. Therefore, the probability of choosing a ghost cell as virtual cell is very small. However, even if a ghost cell is detected as virtual cell, no issues may arise since the SSS peak positions of a real cell (i.e., a true neighbor cell) and an image (i.e., a ghost cell) are close to one another on the order of microseconds (μs).

An uplink spurious cell is one that usually gets detected due to a very low signal level or due to a strong interfering UL transmission when noise or a UL signal happens to have some good correlation with SSS sequences. However, it is not periodic so an uplink spurious cell usually does not show up more than once. An uplink spurious cell is likely to be maintained in the MDB until it is pruned out using some time diversity rule.

In one approach, a spurious cell is chosen to be a neighbor cell having an SSS_SNR that is highest among the ncells in the MDB and any newly detected cells. However, when a UL spurious cell is detected because of strong UL interference and its SSS_SNR is larger than the true cells detected in multiple gaps, a wrong LNA gain decision may be made based on the UL spurious cell timing until it is finally pruned out.

In one aspect, the method for TDD virtual cell selection disclosed herein may be based on one or more assumptions. For example, UL spurious cells may be assumed to be random and cannot show up every time. As another example, the TDD UL/DL configuration on one frequency may be assumed to remain the same and all neighbors on one frequency may be assumed to have the same frame timing. As another example, it may be assumed that the cell frame timing cannot change substantially within a few seconds (e.g., when the UE is moving at 500 Km/hr, the cell timing is changed by 10*5e5/3600/3e8=4.63 us after 10 seconds). As another example, it may be assumed that the UE only needs to avoid picking up UL spurious cells as virtual cells.

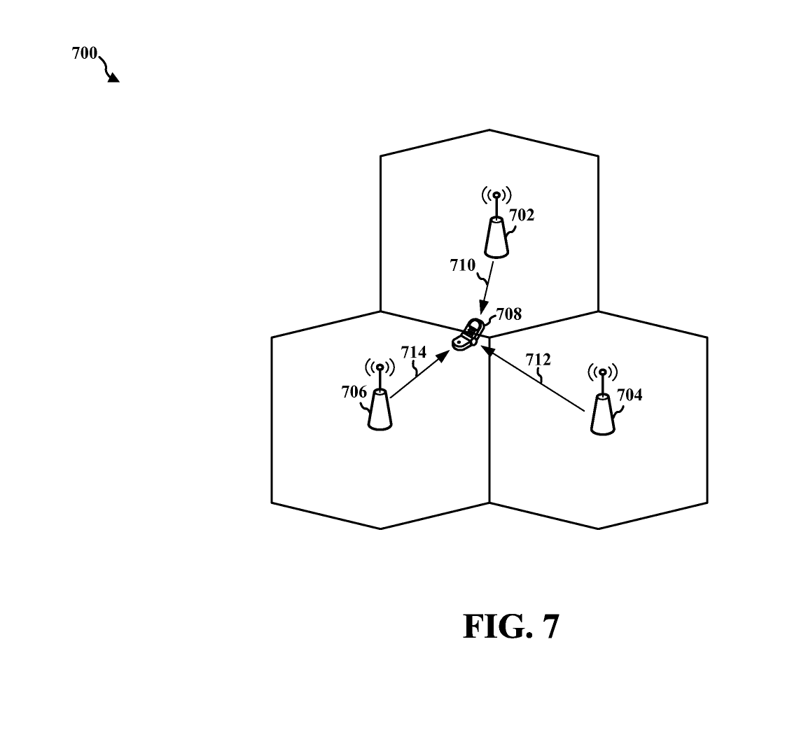

An example of a method for TDD virtual cell selection performed by a UE will now be described with reference to FIG. 7. FIG. 7 is a diagram illustrating a communication system 700. As shown in FIG. 7, the communication system 700 includes cells (also referred to as “nodes” or “eNBs”) 702, 704, and 706, and a UE 708. In an aspect, the communication system 700 may be a wireless communication system implementing LTE communication protocols.

Prior to a measurement gap “n” (e.g., at a measurement gap “n−1”) the UE 708 may have detected cell 702 at least two times, where cell 702 has an SSS_SNR value SNR_702 (n−1). The UE 708 may have also detected cell 704 only once, where cell 704 has an SSS_SNR value SNR 704 (n−1). The UE 708 may store the values SNR_702 (n−1) and SNR 704 (n−1) along with information indicating that the cell 702 has been detected twice and cell 704 has been detected once. At measurement gap n, the UE 708 may group cell 702 in a first group because cell 702 has been detected twice and may group cell 704 in a second group because cell 704 has been detected only once. The UE 708 may determine that the first group includes at least one cell and may select cell 702 as a virtual cell candidate for measurement gap “n”.

In one scenario, during measurement gap n, the UE 708 may detect cell 702 with an SSS_SNR value SNR_702(n) and cell 704 with an SSS_SNR value SNR_704(n). Since cell 704 has now been detected twice (i.e., once during measurement gap “n−1” and once during measurement gap “n”), the UE 708 may group cell 704 in the first group. Accordingly, the first group may now include cells 702 and 704 and the second group may include no cells. The UE 708 may then update the SSS_SNRs of cells 702 and 704 prior to measurement gap “n+1”. The UE 708 may then select a cell having the highest SSS_SNR from the first group as a virtual cell candidate for measurement gap n+1. For example, if SNR_702(n) is greater than SNR_704(n), the UE 708 may select cell 702 as the virtual cell candidate. Otherwise, the UE 708 may select cell 704 as the virtual cell candidate.

In another scenario, during measurement gap n, the UE 708 may detect cell 704 with an SSS_SNR value SNR_704(n) and cell 706 with an SSS_SNR value SNR_706(n). Since cell 704 has now been detected twice (i.e., once during measurement gap “n-1” and once during measurement gap “n”), the UE 708 may group cell 704 in the first group. Since cell 706 has been detected only once, the UE 708 may group cell 706 in the second group. Accordingly, the first group may now include cells 702 and 704 and the second group may include cell 706. The UE 708 may then update the SSS_SNR of cell 704 prior to measurement gap “n+1”. The UE 708 may then select a cell having the highest SSS_SNR from the first group as a virtual cell candidate for measurement gap n+1. For example, if SNR_702(n−1) is greater than SNR_704(n), the UE 708 may select cell 702 as the virtual cell candidate. Otherwise, the UE 708 may select cell 704 as the virtual cell candidate.

In another scenario, during measurement gap n, the UE 708 may detect only cell 706 with an SSS_SNR value SNR_706(n) and may not update the SSS_SNR of cell 702 and the SSS_SNR of cell 704. Since cell 706 has been detected only once, the UE 708 may group cell 706 in the second group. Accordingly, the first group may now include cell 702 and the second group may include cells 704 and 706. Since the first group only includes cell 702, the UE 708 may select cell 702 as the virtual cell candidate for measurement gap n+1.

In another scenario, during measurement gap n, the UE 708 may detect only cell 706 with an SSS_SNR value SNR_706(n). Since cell 706 has been detected only once, the UE 708 may group cell 706 in the second group. If cell 702 is deleted at the end of measurement gap n, the first group may not include any cells and the second group may include cells 704 and 706. The UE 708 may then select a cell having the highest SSS_SNR from the second group as a virtual cell candidate for measurement gap n+1. For example, if SNR_704(n−1) is greater than SNR_706(n), the UE 708 may select cell 704 as the virtual cell candidate. Otherwise, the UE 708 may select cell 706 as the virtual cell candidate.

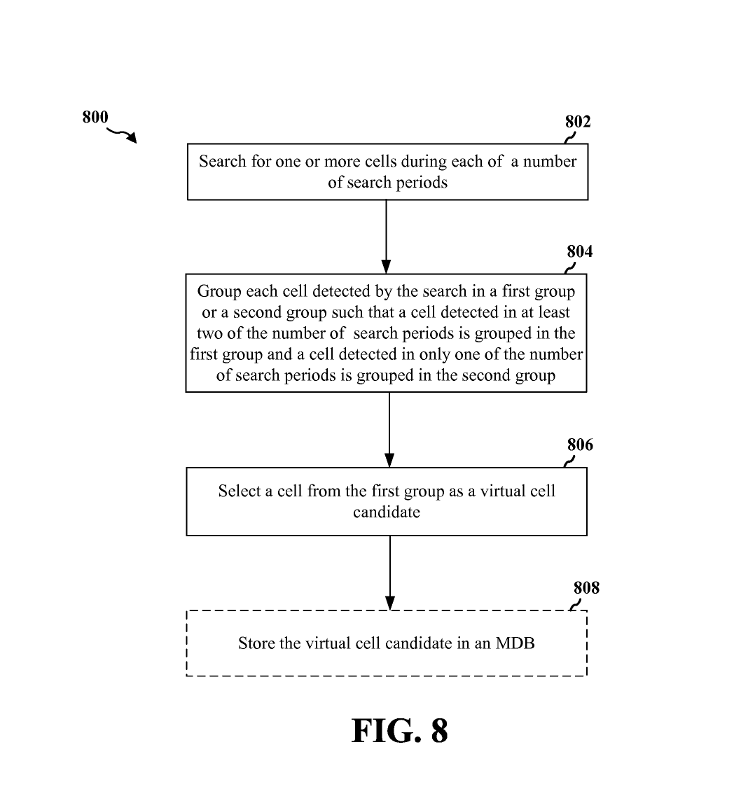

FIG. 8 is a flow chart 800 of a method of wireless communication. The method may be performed by a UE. At step 802, the UE may search for one or more cells during each of a number of search periods. For example, with reference to FIG. 7, the UE 708 may search for one or more cells, such as cells 702, 704, and/or 706, during each of a number of search periods. For example, the search periods may be five consecutive search periods. In one configuration, each search period may be a measurement gap having a duration of one or more subframes. In one configuration, the UE may use a pruning criterion, such as the “two out of five” pruning rule, to prune out UL spurious cells.

At step 804, the UE may group each cell detected by the search in a first group or a second group such that a cell detected in at least two of the number of search periods is grouped in the first group and a cell detected in only one of the number of search periods is grouped in the second group. In one configuration, the UE may group each cell after each of the number of search periods. In one configuration, the first group and/or the second group may include ncells in an MDB and newly detected cells.

At step 806, the UE may select a cell from the first group as a virtual cell candidate when the first group includes at least one cell. In one configuration, the UE may select a cell from the first group based on at least one criterion. For example, the at least one criterion may be a highest SNR value of a signal from a cell in the first group. For example, the signal may be an SSS.

Finally, at step 808, the UE may store the cell selected as the virtual cell candidate in an MDB.

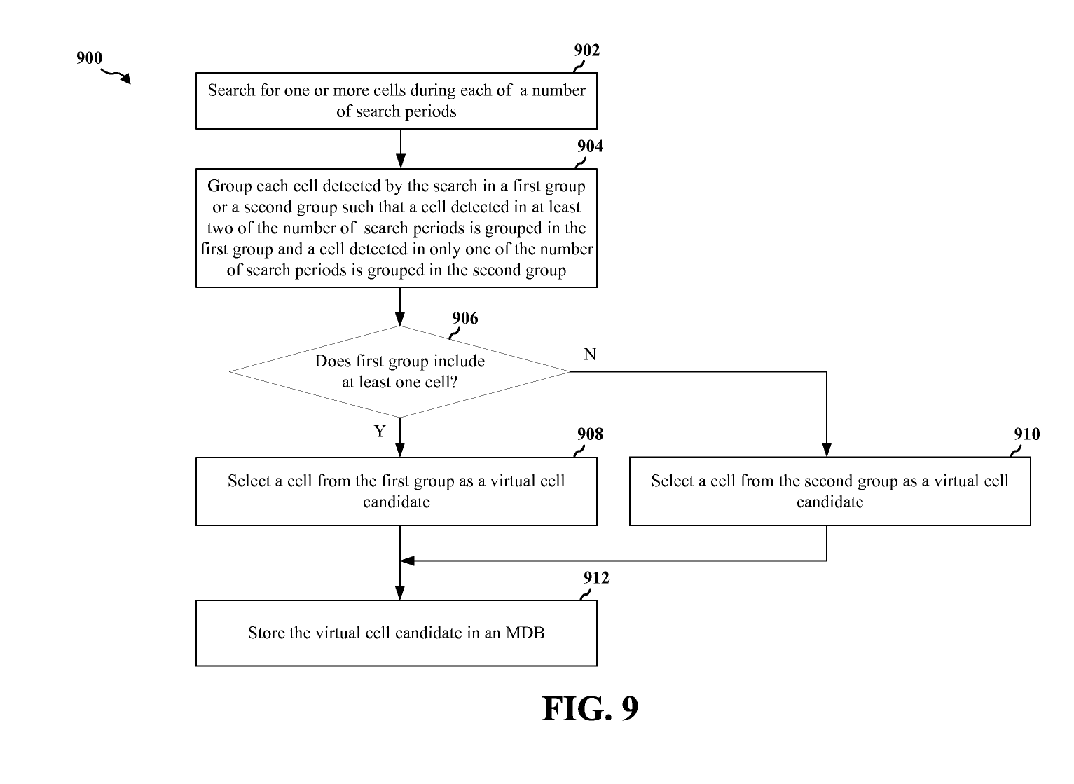

FIG. 9 is a flow chart 900 of a method of wireless communication. The method may be performed by a UE. At step 902, the UE may search for one or more cells during each of a number of search periods. For example, with reference to FIG. 7, the UE 708 may search for one or more cells, such as cells 702, 704, and/or 706, during each of a number of search periods. For example, the search periods may be five consecutive search periods. In one configuration, each search period may be a measurement gap having a duration of one or more subframes. In one configuration, the UE may use a pruning criterion, such as the “two out of five” pruning rule, to prune out UL spurious cells.

At step 904, the UE may group each cell detected by the search in a first group or a second group such that a cell detected in at least two of the number of search periods is grouped in the first group and a cell detected in only one of the number of search periods is grouped in the second group. In one configuration, the UE may group each cell after each of the number of search periods. In one configuration, the first group and/or the second group may include ncells in an MDB and newly detected cells.

At step 906, the UE may determine whether the first group includes at least one cell. If the UE determines that the first group includes at least one cell (906), then at step 908, the UE may select a cell from the first group as a virtual cell candidate when the first group includes at least one cell. In one configuration, the UE may select a cell from the first group based on at least one criterion. For example, the at least one criterion may be a highest SNR value of a signal from a cell in the first group. For example, the signal may be an SSS.

If the UE determines that the first group does not include at least one cell (906), then at step 910, the UE may select a cell from the second group as a virtual cell candidate. In one configuration, the UE may select a cell from the second group based on at least one criterion. For example, the at least one criterion may be a highest SNR value of a signal from a cell in the second group. For example, the signal may be an SSS.

Finally, at step 912, the UE may store the cell selected as the virtual cell candidate in an MDB.

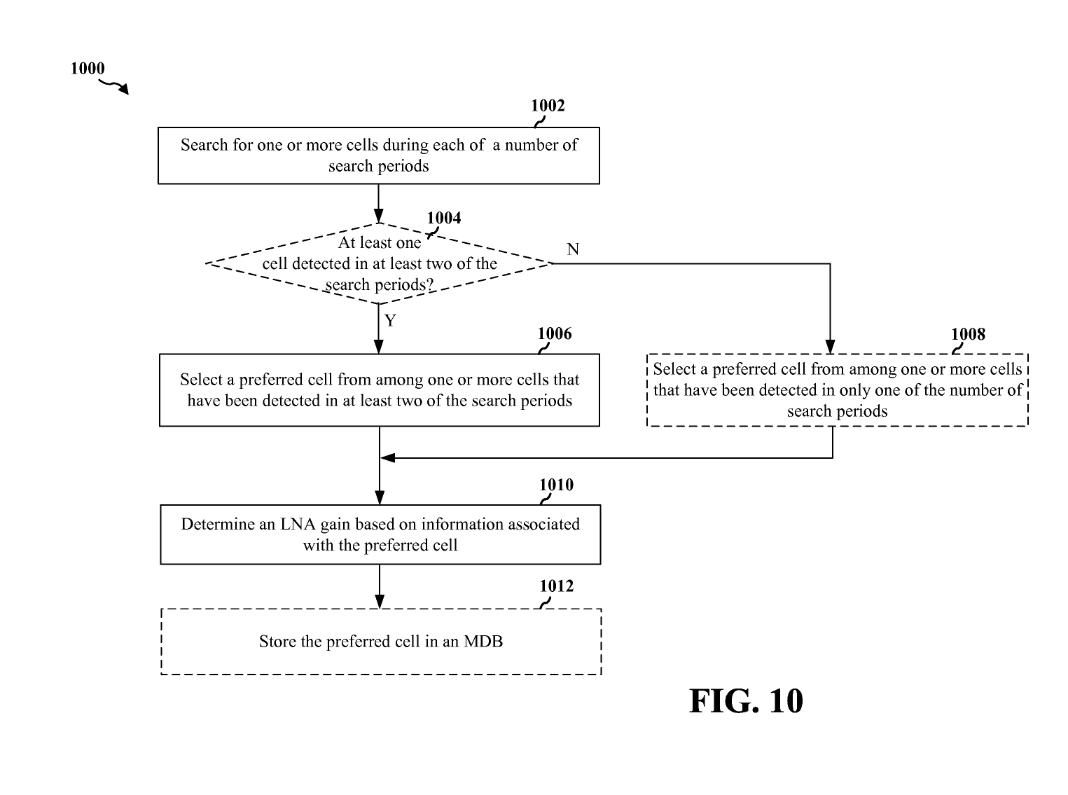

FIG. 10 is a flow chart 1000 of a method of wireless communication. The method may be performed by a UE. At step 1002, the UE may search for one or more cells during each of a number of search periods. For example, with reference to FIG. 7, the UE 708 may search for cells 702, 704, and/or 706 by detecting signals 710, 712, and/or 714 during each of a number of search periods. For example, the search periods may be five consecutive search periods. In one configuration, each search period may be a measurement gap having a duration of one or more subframes. In one configuration, the UE may use a pruning criterion, such as the “two out of five” pruning rule, to prune out UL spurious cells.

At step 1004, the UE may determine whether at least one cell has been detected in at least two of the search periods.

At step 1006, the UE may select a preferred cell from among one or more cells that have been detected in at least two of the search periods when at least one cell has been detected (1004) in at least two of the search periods. In one configuration, the UE may select the preferred cell from among one or more cells that have been detected in at least two of the search periods based on at least one criterion. For example, the at least one criterion may be a highest SNR of the one or more cells that have been detected in at least two of the search periods. In one configuration, the highest SNR of the one or more cells that have been detected in at least two of the search periods may be based on an SNR of an SSS.

Otherwise, at step 1008, the UE may select the preferred cell from among one or more cells that have been detected in only one of the number of search periods when at least one cell has not been detected (1004) in at least two of the search periods. In one configuration, the UE may select the preferred cell from among the one or more cells that have been detected in only one of the number of search periods based on at least one criterion. For example, the at least one criterion may be a highest SNR of the one or more cells that have been detected in only one of the number of search periods. In one configuration, the highest SNR of the one or more cells that have been detected in only one of the number of search periods may be based on an SNR of an SSS.

At step 1010, the UE may determine an LNA gain based on information associated with the preferred cell. For example, the information associated with the preferred cell may be cell timing information of the preferred cell. For example, as discussed supra, such cell timing information may be used by the UE to determine downlink LNA gains.

Finally, at step 1012, the UE may store the preferred cell in an MDB.

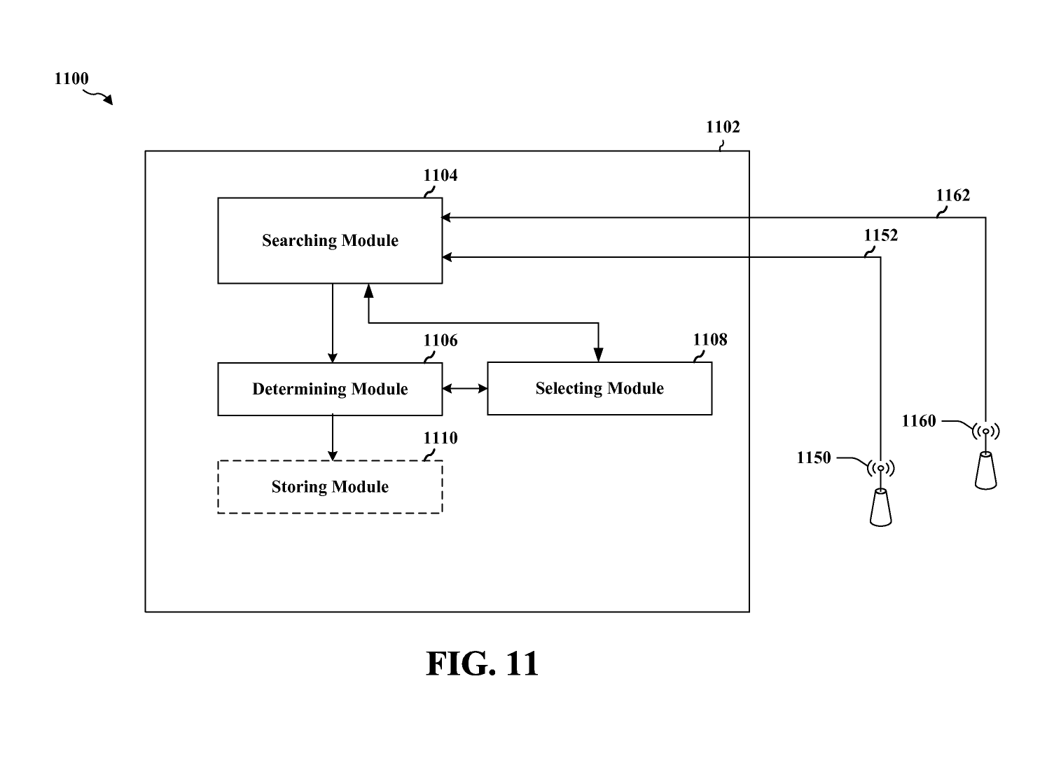

FIG. 11 is a conceptual data flow diagram 1100 illustrating the data flow between different modules/means/components in an exemplary apparatus 1102. The apparatus may be a UE. The apparatus may include a searching module 1104 that searches for one or more cells during each of a number of search periods. For example, the search periods may be five consecutive search periods. In one configuration, the searching module 1104 may include a receiver for receiving signals from one or more eNBs, such as eNBs 1150 and 1160, and may perform the search using the received signals 1152 and 1162.

The apparatus may further include a determining module 1106 that determines whether at least one cell has been detected in at least two of the search periods

The apparatus may further include a selecting module 1108. In one aspect, the cell selecting module 1108 selects a preferred cell from among one or more cells that have been detected in at least two of the search periods when at least one cell has been detected in at least two of the search periods. In another aspect, the cell selecting module 1108 selects the preferred cell from among one or more cells that have been detected in only one of the number of search periods when at least one cell has not been detected in at least two of the search periods.

The apparatus may further include a storing module 1110 that stores the preferred cell in an MDB.

The apparatus may include additional modules that perform each of the steps of the algorithm in the aforementioned flow charts of FIGS. 8 through 10. As such, each step in the aforementioned flow charts of FIGS. 8 through 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

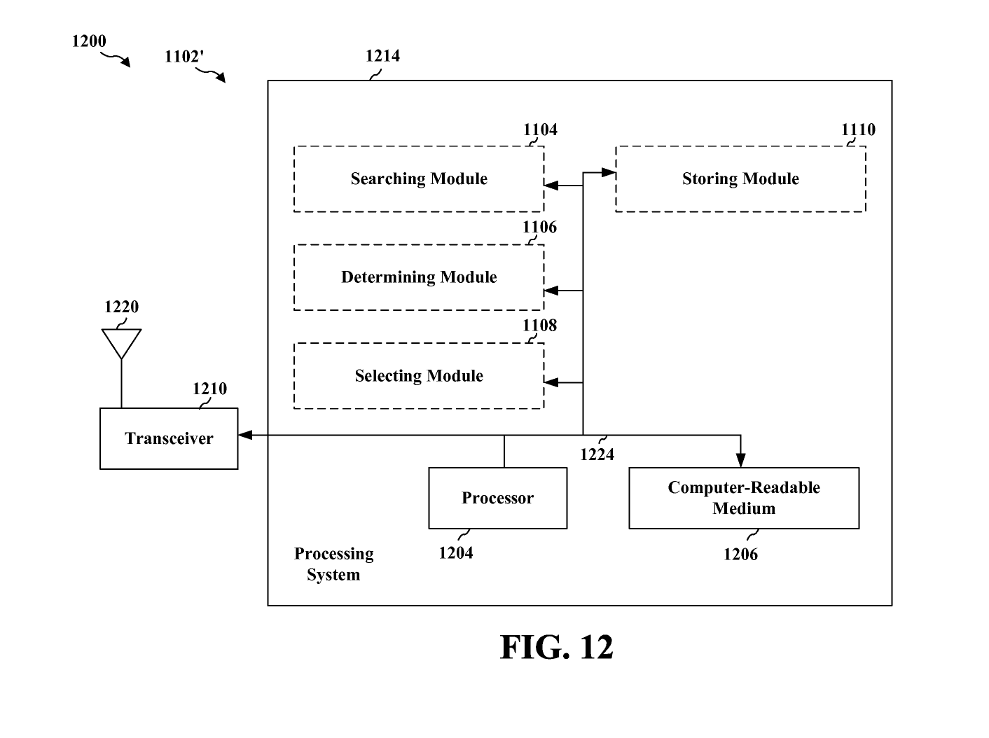

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1106, 1108, and 1110, and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1104, 1106, 1108, and 1110. The modules may be software modules running in the processor 1204, resident/stored in the computer readable medium 1206, one or more hardware modules coupled to the processor 1204, or some combination thereof. The processing system 1214 may be a component of the UE 650 and may include the memory 660 and/or at least one of the TX processor 668, the RX processor 656, and the controller/processor 659.

In one configuration, the apparatus 1102/1102′ for wireless communication includes means for searching for one or more cells during each of a number of search periods, means for grouping each cell detected by the search in a first group or a second group such that a cell detected in at least two of the number of search periods is grouped in the first group and a cell detected in only one of the number of search periods is grouped in the second group, means for determining whether the first group includes at least one cell, means for selecting a cell from the first group as a virtual cell candidate when the first group includes at least one cell, means for selecting a cell from the second group as the virtual cell candidate when the first group does not include at least one cell, and means for storing the virtual cell candidate in an MDB. The aforementioned means may be one or more of the aforementioned modules of the apparatus 902 and/or the processing system 1214 of the apparatus 1102′ configured to perform the functions recited by the aforementioned means. As described supra, the processing system 1214 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
searching for one or more cells during each of a number of search periods;
selecting a preferred cell from among one or more cells that have been detected in at least two of the search periods when at least one cell has been detected in at least two of the search periods; and
determining a low-noise amplifier (LNA) gain based on information associated with the preferred cell.

2. The method of claim 1, further comprising selecting the preferred cell from among one or more cells that have been detected in only one of the number of search periods when at least one cell has not been detected in at least two of the search periods.

3. The method of claim 1, further comprising storing the preferred cell in a measurement database (MDB).

4. The method of claim 1, wherein selecting the preferred cell from among one or more cells that have been detected in at least two of the search periods is based on at least one criterion.

5. The method of claim 4, wherein the at least one criterion comprises a highest signal to noise ratio (SNR) of the one or more cells that have been detected in at least two of the search periods.

6. The method of claim 5, wherein the highest SNR of the one or more cells that have been detected in at least two of the search periods is based on an SNR of a secondary synchronization signal (SSS).

7. The method of claim 2, wherein selecting the preferred cell from among the one or more cells that have been detected in only one of the number of search periods is based on at least one criterion.

8. The method of claim 7, wherein the at least one criterion comprises a highest signal to noise ratio (SNR) of the one or more cells that have been detected in only one of the number of search periods.

9. The method of claim 8, wherein the highest SNR of the one or more cells that have been detected in only one of the number of search periods is based on an SNR of a secondary synchronization signal (SSS).

10. The method of claim 1, wherein the number of search periods comprises five consecutive search periods.

11. An apparatus for wireless communication, comprising:
means for searching for one or more cells during each of a number of search periods;
means for selecting a preferred cell from among one or more cells that have been detected in at least two of the search periods when at least one cell has been detected in at least two of the search periods; and
means for determining a low-noise amplifier (LNA) gain based on information associated with the preferred cell.

12. The apparatus of claim 11, further comprising means for selecting the preferred cell from among one or more cells that have been detected in only one of the number of search periods when at least one cell has not been detected in at least two of the search periods.

13. The apparatus of claim 11, further comprising means for storing the preferred cell in a measurement database (MDB).

14. The apparatus of claim 11, wherein selecting the preferred cell from among one or more cells that have been detected in at least two of the search periods is based on at least one criterion.

15. The apparatus of claim 14, wherein the at least one criterion comprises a highest signal to noise ratio (SNR) of the one or more cells that have been detected in at least two of the search periods.

16. The apparatus of claim 15, wherein the highest SNR of the one or more cells that have been detected in at least two of the search periods is based on an SNR of a secondary synchronization signal (SSS).

17. The apparatus of claim 12, wherein selecting the preferred cell from among the one or more cells that have been detected in only one of the number of search periods is based on at least one criterion.

18. The apparatus of claim 17, wherein the at least one criterion comprises a highest signal to noise ratio (SNR) of the one or more cells that have been detected in only one of the number of search periods.

19. The apparatus of claim 18, wherein the highest SNR of the one or more cells that have been detected in only one of the number of search periods is based on an SNR of a secondary synchronization signal (SSS).

20. The apparatus of claim 11, wherein the number of search periods comprises five consecutive search periods.

21. An apparatus for wireless communication, comprising:
a processing system configured to:
search for one or more cells during each of a number of search periods;
select a preferred cell from among one or more cells that have been detected in at least two of the search periods when at least one cell has been detected in at least two of the search periods; and
determine a low-noise amplifier (LNA) gain based on information associated with the preferred cell.

22. The apparatus of claim 21, the processing system further configured to select the preferred cell from among one or more cells that have been detected in only one of the number of search periods when at least one cell has not been detected in at least two of the search periods.

23. The apparatus of claim 21, the processing system further configured to store the preferred cell in a measurement database (MDB).

24. The apparatus of claim 21, wherein the preferred cell is selected from among one or more cells that have been detected in at least two of the search periods based on at least one criterion.

25. The apparatus of claim 24, wherein the at least one criterion comprises a highest signal to noise ratio (SNR) of the one or more cells that have been detected in at least two of the search periods.

26. The apparatus of claim 25, wherein the highest SNR of the one or more cells that have been detected in at least two of the search periods is based on an SNR of a secondary synchronization signal (SSS).

27. The apparatus of claim 22, wherein the preferred cell is selected from among the one or more cells that have been detected in only one of the number of search periods based on at least one criterion.

28. The apparatus of claim 27, wherein the at least one criterion comprises a highest signal to noise ratio (SNR) of the one or more cells that have been detected in only one of the number of search periods.

29. The apparatus of claim 28, wherein the highest SNR of the one or more cells that have been detected in only one of the number of search periods is based on an SNR of a secondary synchronization signal (SSS).

30. The apparatus of claim 21, wherein the number of search periods comprises five consecutive search periods.

31. A computer program product, comprising:
a computer-readable medium comprising code for:
searching for one or more cells during each of a number of search periods;
selecting a preferred cell from among one or more cells that have been detected in at least two of the search periods when at least one cell has been detected in at least two of the search periods; and
determining a low-noise amplifier (LNA) gain based on information associated with the preferred cell.

32. The computer program product of claim 31, the computer-readable medium further comprising code for selecting the preferred cell from among one or more cells that have been detected in only one of the number of search periods when at least one cell has not been detected in at least two of the search periods.

33. The computer program product of claim 31, the computer-readable medium further comprising code for storing the preferred cell in a measurement database (MDB).
